(19) United States
(12) Patent Application Publication
(10) Pub. No.: US 2024/0066952 A1
(43) Pub. Date: Feb. 29, 2024

(54) HEATING CONTROL METHOD FOR VEHICLE

(71) Applicant: HONDA MOTOR CO., LTD., Tokyo (JP)

(72) Inventor: Toru OGAKI, Tokyo (JP)

(73) Assignee: HONDA MOTOR CO., LTD., Tokyo (JP)

(21) Appl. No.: 18/238,862

(22) Filed: Aug. 28, 2023

(30) Foreign Application Priority Data
Aug. 31, 2022 (JP) 2022-137845

(51) Int. Cl. B60H 1/00; B60H 1/14

(52) U.S. Cl. CPC B60H 1/00878; B60H 1/00278; B60H 1/00492; B60H 1/143; B60H 2001/00949

(57) ABSTRACT

A vehicle has a chargeable battery and an air conditioner heating a vehicle compartment. The vehicle travels by electric power of the battery. A heating control method for the vehicle includes a start time acquisition step in which a start time of the vehicle is acquired based on schedule information of the vehicle, a charge step in which the battery is charged, from a first time before the start time, with an external power supply, a warming step in which the battery is warmed, from a second time between a charge completion time and the start time, by electric power from the external power supply, and a heating step in which the vehicle compartment is heated after the start time. An operation mode of the heating step includes a battery-heat absorption mode in which the vehicle compartment is heated through a use of heat stored in the battery.

### CROSS-REFERENCE TO RELATED APPLICATIONS

This application claims priority from Japanese Patent Application No. 2022-137845 filed on Aug. 31, 2022, the entire subject-matter of which is incorporated herein by reference.

### TECHNICAL FIELD

The present disclosure relates to a heating control method for a vehicle.

### BACKGROUND ART

In recent years, researches and developments have been conducted on a secondary battery (hereinafter, also referred to as a battery) that contributes to an increase in energy efficiency in order to allow more users to access affordable, reliable, sustainable, and advanced energy.

The battery is mounted on, for example, an electric vehicle and serves as an electric power source for an electric motor as a drive source and various devices. The battery can be charged via a charger with electric power from an external power supply. In the electric vehicle, a charging plug coupled to the external power supply is connected to the vehicle to charge the battery after use of the vehicle and until the vehicle is used next time, thereby eliminating need for charging while the vehicle is being used. Further, in recent years, there has been proposed a technique for appropriately selecting a charge start time in order to save an electricity cost associated with charge.

While the battery is being charged, the battery and the charger generate heat, and the heat generated by the battery and the charger may be effectively used without being wasted. For example, JP2020-179839A discloses a vehicle heat pump system which enables to use heat generated by charging a battery, to heat a vehicle compartment. In addition, JP2010-272285A discloses a technique in which heat generated by a charger is used to heat a coolant supplied to a battery.

When heat stored in a battery is absorbed (heat-pumped) and used for heating a vehicle compartment, it is desired to adjust a battery temperature to be appropriate before a vehicle starts, in order to efficiently perform heating.

### SUMMARY OF INVENTION

The present disclosure provides a heating control method for a vehicle, which enables to adjust a battery temperature to be appropriate before the vehicle starts, and efficiently heat a vehicle compartment through a use of heat stored in a battery.

An aspect of the present disclosure relates to a heating control method for a vehicle including a battery chargeable with electric power from an external power supply, and an air conditioner that enables to heat a vehicle compartment with consumption of electric power of the battery, the vehicle being capable of traveling by the electric power of the battery, the heating control method including:
a start time acquisition step in which a start time of the vehicle is acquired based on schedule information of the vehicle;
a charge step in which the battery is charged, from a first time before the start time, with the electric power from the external power supply;
a warming step in which the battery is warmed, from a second time between a completion time of the charge of the battery and the start time, by the electric power from the external power supply; and
a heating step in which the vehicle compartment is heated after the start time,
in which an operation mode of the heating step includes a battery-heat absorption mode in which the vehicle compartment is heated through a use of heat stored in the battery due to charge and warming of the battery, and
the first time and the second time are determined based on the start time.

According to the present disclosure, it is possible to adjust a battery temperature to be appropriate before the vehicle starts, and efficiently heat a vehicle compartment through the use of heat stored in a battery.

### BRIEF DESCRIPTION OF DRAWINGS

FIG. 1 is a block diagram showing an example of a schematic configuration of a vehicle V.

FIG. 2 shows a configuration of a temperature control device 20.

FIG. 3 shows a flow of heat stored in a battery BAT before heating a vehicle compartment.

FIG. 4 shows a flow of heat when heating the vehicle compartment in a battery-heat absorption mode.

FIG. 5 shows a flow of heat when heating the vehicle compartment in an outside-air-heat absorption mode.

FIG. 6 is a graph showing a change over time in a battery temperature based on a first comparative example.

FIG. 7 is a graph showing a change over time in a battery temperature based on a second comparative example.

FIG. 8 is a graph showing a change over time in a battery temperature based on a heating control method according to the present embodiment.

FIG. 9A is a graph showing a relationship between a battery temperature and an effective capacity of the battery BAT, FIG. 9B is a graph showing a relationship between the battery temperature at a start time of the vehicle V and a ratio (expressed by a percentage) of an electric power amount P1 in the battery-heat absorption mode to an electric power amount P2 in the outside-air-heat absorption mode, and FIG. 9C is a graph showing a relationship between the battery temperature and an electric power consumption amount of a battery heater ECH1.

FIG. 10 is a flowchart showing an example of processing for acquiring a charge start time and a warming start time of the battery BAT.

### DESCRIPTION OF EMBODIMENTS

Hereinafter, an embodiment of a heating control method for a vehicle according to the present disclosure will be described with reference to the accompanying drawings.

[Vehicle]

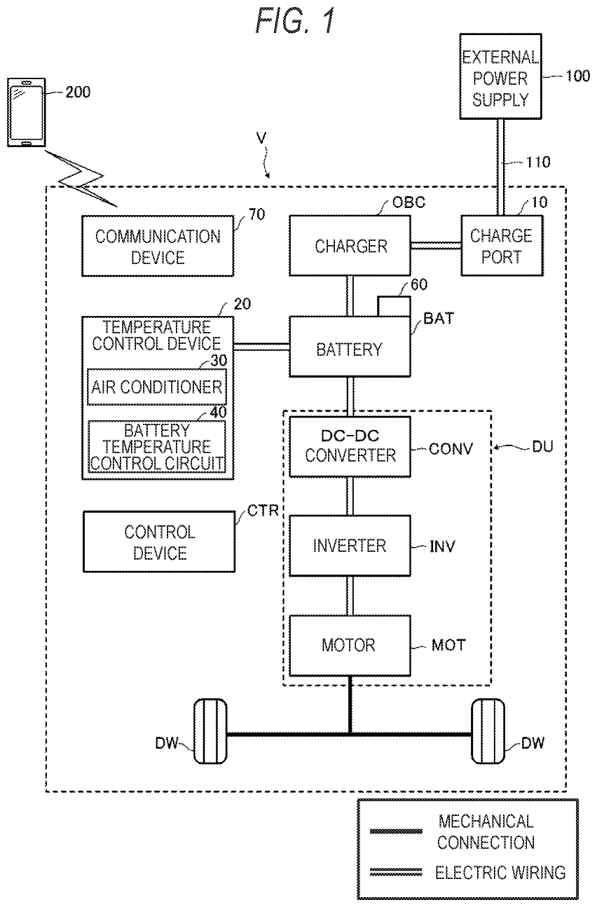

A vehicle V in the present embodiment is, for example, an electric vehicle such as a plug-in hybrid vehicle or an electric automobile, includes a battery BAT capable of storing electric power from an external power supply 100 provided in a charging station, a home, or the like as shown in FIG. 1, and is capable of traveling by the electric power stored in the battery BAT. The battery BAT is implemented by stacking a plurality of battery cells (not shown), and is, for example, a lithium ion battery or a nickel hydrogen battery. In addition, the battery BAT is provided with a temperature sensor 60 that detects a temperature of the battery BAT (hereinafter also referred to as a battery temperature). In FIG. 1, a thick solid line indicates mechanical connection, and a double line indicates electric wiring. In addition, the configuration shown in FIG. 1 is an example, and a part of the configuration may be omitted, or another configuration may be added.

The vehicle V is provided with a charge port 10 and a charger OBC (On-Board Charger) disposed between the charge port 10 and the battery BAT. When a charge plug of a charge cable 110 of the external power supply 100 is connected (plugged in) to the charge port 10, the charger OBC converts a current introduced from the external power supply 100 via the charge port 10, for example, converts an AC during normal charge into a DC, and outputs the converted DC to the battery BAT. In this way, the battery BAT stores electric power supplied from the external power supply 100. The configuration for charging the battery BAT by the external power supply 100 is not limited thereto. For example, the battery BAT may be charged by a configuration in which a power receiving coil or the like capable of receiving electric power transmitted from the external power supply 100 in a non-contact manner is provided in the vehicle V.

The vehicle V includes a drive unit DU, a temperature control device 20, a control device CTR, and a communication device 70.

The drive unit DU includes a DC-DC converter CONV, an inverter INV, and a motor MOT. The DC-DC converter CONV boosts electric power supplied from the battery BAT and outputs the boosted electric power to the inverter INV. The inverter INV converts a DC supplied from the DC-DC converter CONV into an AC and outputs the AC to the motor MOT. The motor MOT is, for example, a three-phase AC motor, and is driven by electric power supplied from the battery BAT via the DC-DC converter CONV and the inverter INV. An output of the motor MOT is transmitted to drive wheels DW of the vehicle V, and thus the vehicle V travels.

The control device CTR controls the charger OBC, the battery BAT, the drive unit DU, the temperature control device 20, and the communication device 70. In addition, the control device CTR also controls a battery heater ECH1 and a heating heater ECH2 to be described later. The control device CTR is implemented by an electronic control unit (ECU) including a processor, a memory, an interface, and the like. The control device CTR may be implemented by a plurality of control devices, that is, the control device may be provided for each of the above-described control objects.

The communication device 70 includes a wireless module for connecting to a cellular network or a Wi-Fi network. The communication device 70 is a communication interface that communicates, via a network such as the Internet or Ethernet, with a user terminal 200 (for example, a smartphone or a tablet terminal) operated by a user of the vehicle V.

The communication device 70 cooperates with schedule information of the vehicle V registered in advance by the user in the user terminal 200. The control device CTR acquires the schedule information of the vehicle V via the communication device 70. Then, the control device CTR acquires a start time of the vehicle V based on the schedule information. Here, the start time of the vehicle V includes a time when the vehicle V starts and a pre-air-conditioning start time when an operation of an air conditioner is started before the start. When the schedule information of the vehicle V is stored in an external server different from the user terminal 200, the communication device 70 may communicate with the external server via a network, and the control device CTR may acquire the schedule information of the vehicle V via the communication device 70 and acquire the start time of the vehicle V based on the schedule information.

[Temperature Control Device]

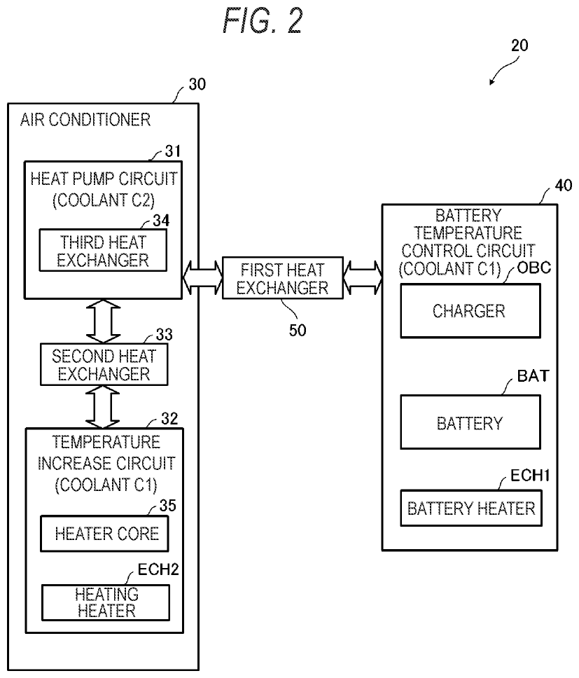

As shown in FIG. 2, the temperature control device 20 includes an air conditioner 30 that heats or cools a vehicle compartment, a battery temperature control circuit 40 that warms or cools down the battery BAT, and a first heat exchanger 50 that performs heat exchange between a heat pump circuit 31 of the air conditioner 30 and the battery temperature control circuit 40.

[Battery Temperature Control Circuit]

A liquid coolant C1 (for example, water) circulates inside the battery temperature control circuit 40, and heat exchange is performed between the battery BAT and the charger OBC.

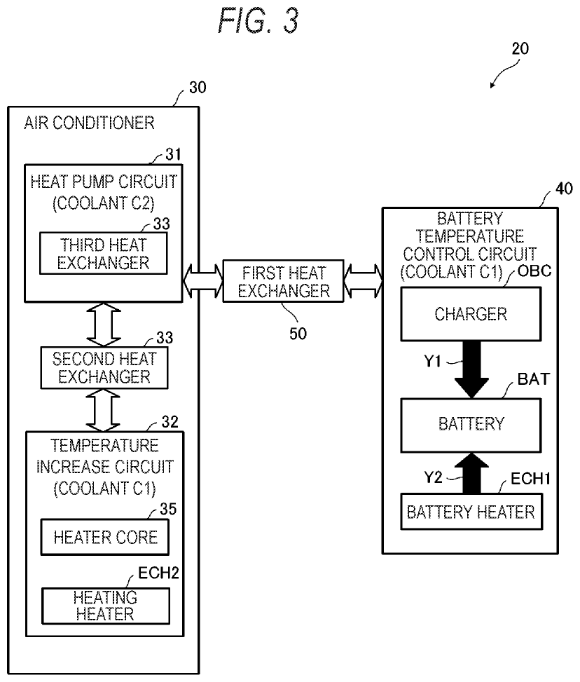

Specifically, in the battery temperature control circuit 40, when the battery BAT is charged with the electric power from the external power supply 100 before the start of the vehicle V, the charger OBC generates heat and has a high temperature. The charger OBC performs heat exchange with the coolant C1 flowing through the battery temperature control circuit 40, the charger OBC is cooled down, and the coolant C1 is warmed. The warmed coolant C1 circulates through the battery temperature control circuit 40 to perform heat exchange with the battery BAT, thereby warming the battery BAT. A black arrow Y1 shown in FIG. 3 indicates transfer of heat from the charger OBC to the battery BAT. In this way, the battery BAT stores heat from the charger OBC via the coolant C1 during charging by the external power supply 100.

The battery temperature control circuit 40 is provided with the battery heater ECH1. The battery heater ECH1 is, for example, an electric heater (electric coolant heater), and operates by electric power from the external power supply 100 when connected to the external power supply 100, and operates by electric power from the battery BAT when not connected to the external power supply 100. Specifically, the coolant C1 is warmed by the battery heater ECH1, and the warmed coolant C1 performs heat exchange with the battery BAT to warm the battery BAT. A black arrow Y2 shown in FIG. 3 indicates transfer of heat from the battery heater ECH1 to the battery BAT. In this way, the battery BAT stores the heat from the battery heater ECH1 via the coolant C1.

Further, the battery BAT generates heat by itself when being charged by the external power supply 100, and stores the heat generated by itself.

Since the battery BAT has a large thermal capacity and easily stores heat, as described above, the charge plug coupled to the external power supply 100 is connected to the vehicle V after the use of the vehicle V until the next use of the vehicle V to charge the battery BAT, and thus the heat from the charger OBC, the heat from the battery heater ECH1, and the heat generated by the battery BAT itself are stored in the battery BAT.

[Air Conditioner]

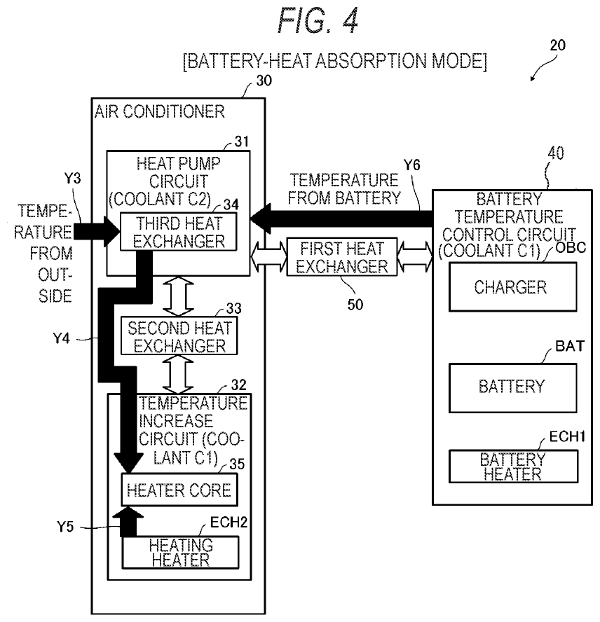

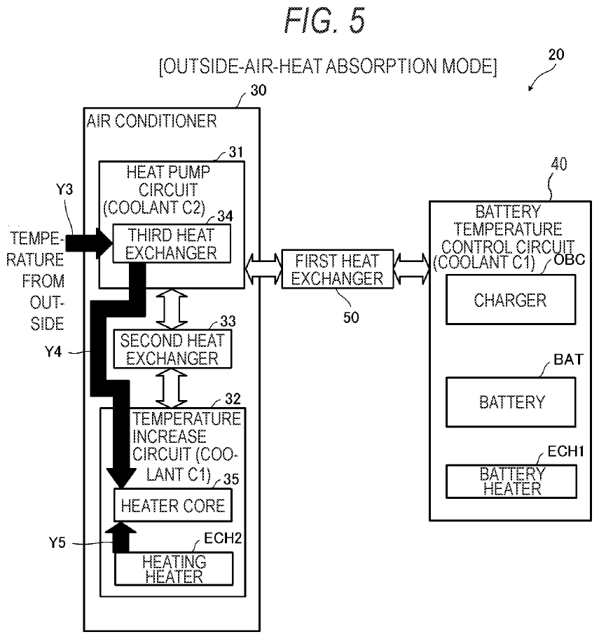

The air conditioner 30 includes the heat pump circuit 31, a temperature increase circuit 32, and a second heat exchanger 33 that performs heat exchange between the heat pump circuit 31 and the temperature increase circuit 32. The heat pump circuit 31 includes a refrigeration cycle including a compressor, a condenser, an expansion valve, an evaporator, and the like, and a liquid coolant C2 (for example, an air-conditioning coolant) flows therein. The condenser (hereinafter, referred to as a third heat exchanger 34) of the heat pump circuit 31 is exposed to outside air, and is capable of absorbing heat (that is, heat-pumping) from the outside air under a low-temperature environment when heating the vehicle compartment. A black arrow Y3 shown in FIGS. 4 and 5 indicates transfer of heat from the outside air to the third heat exchanger 34.

The liquid coolant C1 (for example, water) flows inside the temperature increase circuit 32. The coolant in the temperature increase circuit 32 and the coolant in the battery temperature control circuit 40 are both the coolant C1 and are common. The coolant C1 in the temperature increase circuit 32 performs heat exchange with the coolant C2 in the heat pump circuit 31 via the second heat exchanger 33, and thus a temperature thereof is increased. A black arrow Y4 shown in FIGS. 4 and 5 indicates transfer of heat from the third heat exchanger 34 to the temperature increase circuit 32 via the second heat exchanger 33.

The heating heater ECH2 is provided in the temperature increase circuit 32, and the temperature of the coolant C1 in the temperature increase circuit 32 is also increased by heat from the heating heater ECH2. The heating heater ECH2 is, for example, an electric heater (electric coolant heater). A black arrow Y5 shown in FIGS. 4 and 5 indicates transfer of heat from the heating heater ECH2 to a heater core 35.

The temperature of the coolant C1 in the temperature increase circuit 32 is increased by heat transferred from the heat pump circuit 31 to the temperature increase circuit 32 via the second heat exchanger 33 and heat from the heating heater ECH2, and heat exchange is performed with conditioned air in the heater core 35 to heat the vehicle compartment.

[Heating Mode]

(Battery-Heat Absorption Mode)

As described above, the first heat exchanger 50 enabling heat exchange between the coolant C1 and the coolant C2 is provided between the heat pump circuit 31 and the battery temperature control circuit 40. Therefore, heat (arrow Y1 in FIG. 3) from the charger OBC during charge, heat (arrow Y2 in FIG. 3) from the battery heater ECH1, and heat (not shown) stored in the battery BAT by self-heat-generation of the battery BAT during charge are transmitted to the heat pump circuit 31 via the first heat exchanger 50. A black arrow Y6 shown in FIG. 4 indicates transfer of heat from the battery temperature control circuit 40 to the heat pump circuit 31. Then, the heat (arrow Y6 in FIG. 4) from the battery BAT is transmitted to the temperature increase circuit 32 via the second heat exchanger 33 together with heat (arrow Y3 in FIG. 4) from the outside air, and heat (arrow Y5 in FIG. 4) from the heating heater ECH2 is applied to heat the vehicle compartment. That is, in this heating mode, the heat stored in the battery BAT is absorbed and used to heat the vehicle compartment in addition to outside-air-heat absorption. Hereinafter, heat absorption from the battery BAT is also referred to as battery-heat absorption, and an operation mode in which heating of the vehicle compartment is performed by battery-heat absorption is also referred to as a battery-heat absorption mode. FIG. 4 shows a flow of heat in the battery-heat absorption mode.

(Outside-Air-Heat Absorption Mode)

On the other hand, an operation mode in which the vehicle compartment is heated by absorbing heat from the outside air without using the heat stored in the battery BAT is also referred to as an outside-air-heat absorption mode. FIG. 5 shows a flow of heat in the outside-air-heat absorption mode.

(Details of Battery-Heat Absorption Mode)

In the battery-heat absorption mode in which heat is absorbed from the battery BAT having a temperature higher than that of the outside air, it is possible to reduce an electric power amount of the battery BAT consumed by the air conditioner 30 at the time of heating the vehicle compartment, as compared to the outside-air-heat absorption mode, and thus an electricity cost is reduced. Therefore, it is possible to reduce a decrease in a state of charge (SOC) of the battery BAT caused by heating, and it is possible to reduce a decrease in a cruising distance of the vehicle V.

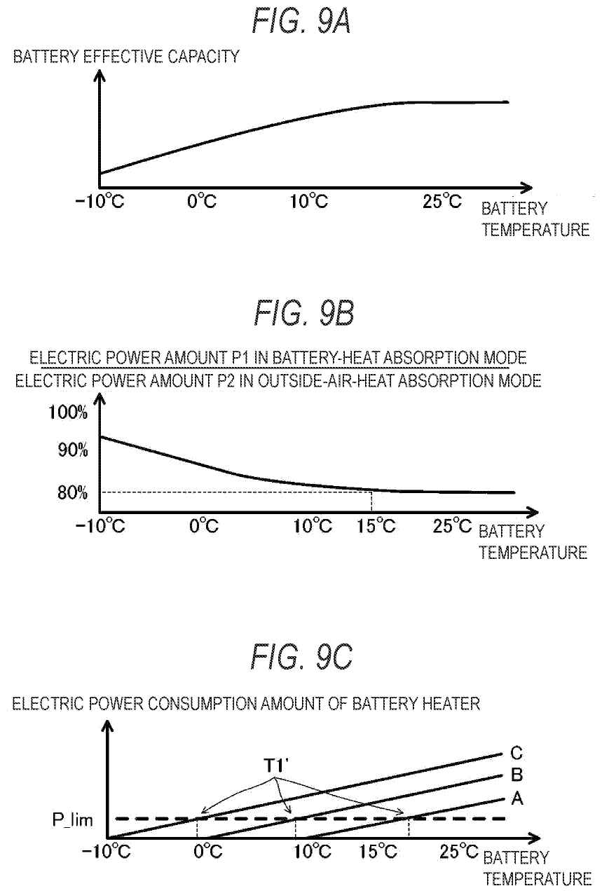

In the battery-heat absorption mode, as the battery temperature is increased, an electric power amount of the battery BAT consumed for heating the vehicle compartment is reduced (see FIG. 9B, details will be described later). In other words, when the battery temperature is increased, heating efficiency by battery-heat absorption is improved.

Before the vehicle V is started, as described above, when the battery BAT is charged and warmed by the battery heater ECH1, the battery BAT stores heat and is warmed. However, if the vehicle V is left in a low-pressure environment after the battery BAT is warmed, the battery temperature decreases toward an outside air temperature, and thus the heating efficiency by the battery-heat absorption deteriorates. The battery BAT is warmed again after the battery temperature is lowered, and thus an electricity fee is increased along with consumption of electric power from the external power supply 100.

A heating control method according to the present embodiment includes a charge step in which the battery BAT is charged before the start of the vehicle V, a warming step in which the battery BAT is warmed before the start of the vehicle V, and a heating step in which heating is performed by battery-heat absorption, and the charge step and the warming step are performed at an appropriate timing such that the electric power amount from the external power supply 100 does not increase.

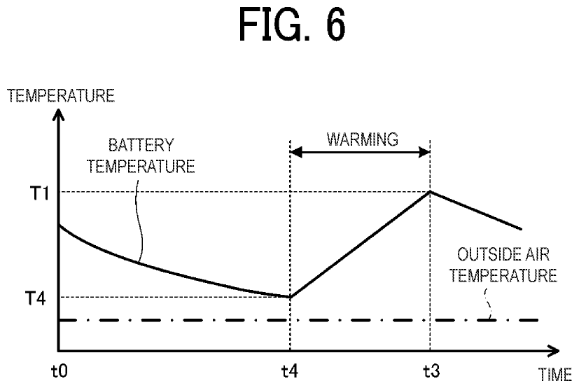

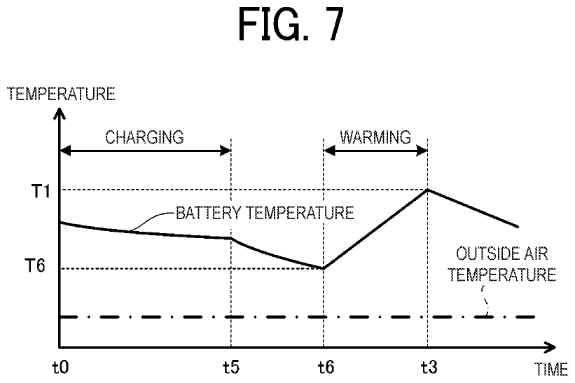

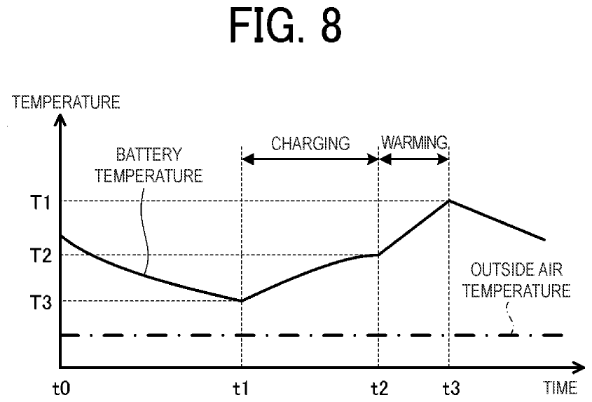

Prior to description of the heating control method according to the present embodiment, first, as a first comparative example (see FIG. 6), control will be described under which the battery BAT is not charged and the battery heater ECH1 is operated to warm the battery BAT to a predetermined temperature T1 before the start of the vehicle V. A time t3 in FIG. 6 is a time when the vehicle V is started (hereinafter, the time t3 is also referred to as the start time), and the control device CTR acquires the time t3 by cooperating with the schedule information of the vehicle V. In addition, the predetermined temperature T1 is a target temperature at the start time t3, and is also a target temperature when warming is completed. Hereinafter, the temperature T1 is referred to as the target temperature T1, and details of the target temperature T1 will be described later. In FIG. 6, it is assumed that the outside air temperature is low (for example, −10° C.) and the battery temperature decreases to the vicinity of the outside air temperature when the battery BAT is not charged or warmed. In addition, in FIG. 6, a solid line indicates the battery temperature, and a dotted-dashed line indicates the outside air temperature. The same applies to FIGS. 7 and 8 to be described later.

A time t0 is the time to when the charge cable 110 is plugged into the charge port 10. However, in FIG. 6, the battery BAT is not charged. At the time t0, since the vehicle V is stopped and the battery BAT is not charged or warmed, the battery temperature gradually decreases from the time t0. Then, at a warming start time t4 calculated by calculation backward from the start time t3 of the vehicle V, the target temperature T1, and an output (for example, a maximum output) of the battery heater ECH1, the battery heater ECH1 is operated by the electric power from the external power supply 100 to start warming the battery BAT. Due to the warming, the battery temperature rises from a temperature T4 at the warming start time t4 to the target temperature T1 at the start time t3. After the time t3, the heat stored in the battery BAT is used to heat the vehicle compartment, and the battery temperature decreases.

In the first comparative example, a difference between the battery temperature T4 at the warming start time t4 and the target temperature T1 at the start time t3 is large, and thus a warming period is long. Therefore, an electric power consumption amount of the battery heater ECH1 is large, and an electricity fee associated with the electric power consumption amount may be high.

Next, as a second comparative example (see FIG. 7), control will be described under which the battery BAT is charged with the electric power from the external power supply 100 before the start of the vehicle V, and the battery heater ECH1 is operated by the electric power from the external power supply 100 to cause the battery temperature to reach the target temperature T1. In the second comparative example, the battery BAT is charged immediately from the time to when the charge cable 110 is plugged into the charge port 10. The time t0, the time t3, and the target temperature T1 are the same as those in FIG. 6.

By charging the battery BAT from the time to, heat is stored in the battery BAT due to heat from the charger OBC and self-generated heat. When the SOC of the battery BAT reaches a target SOC at a time t5, the charge of the battery BAT ends. In the example in FIG. 7, since a difference between the battery temperature and the outside air temperature is large during the charge period, a large amount of heat is released from the battery BAT to the outside air. Since the heat released to the outside air is more than the heat stored in the battery BAT, the battery temperature decreases during the charge period. From the charge completion time 15 to a warming start time t6, the battery BAT is not charged or warmed, the heat of the battery BAT is released to the outside air, the battery temperature further decreases, and the battery temperature becomes T6 at the time t6. Then, at the warming start time t6 calculated by calculation backward from the start time t3 of the vehicle V, the target temperature T1, and the output of the battery heater ECH1 (the maximum output as in the first comparative example), the battery heater ECH1 is operated by the electric power from the external power supply 100 to start warming the battery BAT. Due to the warming, the battery temperature rises from T6 at the warming start time t6 to the target temperature T1 at the start time 3. After the time t3, the heat stored in the battery BAT is used to heat the vehicle compartment, and the battery temperature decreases.

In the second comparative example, there is a period in which the battery BAT is not charged or warmed between the charge period and the warming period, and a part of the heat stored in the battery BAT due to the charge becomes waste heat. Therefore, it is necessary to compensate for the waste heat by the battery heater ECH1, and the warming period is lengthened. Therefore, an electric power consumption amount of the battery heater ECH1 is large, and an electricity fee associated with the electric power consumption amount may be high.

Next, the heating control method according to the present embodiment will be described with reference to FIG. 8.

In the present embodiment, unlike the second comparative example, the control device CTR does not start charging the battery BAT at the time t0. At the time t0, since the vehicle V is stopped and the battery BAT is not charged or warmed, the battery temperature gradually decreases from the time t0.

At a time t1 when a predetermined time elapses from the time to, charge of the battery BAT is started. When the charge of the battery BAT is started, the battery BAT stores heat from the charger OBC and self-generated heat, and the battery temperature rises from a temperature T3 at the charge start time t1.

The charge start time t1 is determined based on the start time t3 such that an electric power consumption amount required for warming the battery BAT after the charge does not increase. Specifically, the charge start time t1 is a time when the predetermined time elapses from the plug-in time t0. By determining the charge start time t1 in this way, a charge period can be closer to the start time t3 than in a case where charge is started at the plug-in time t0 (that is, the second comparative example). Therefore, it is possible to prevent occurrence of a period in which the heat stored in the battery BAT by charging becomes waste heat before the start of the vehicle V as in the period from the time 15 to the time t6 in the second comparative example. Detailed processing for determining the charge start time will be described later.

The battery BAT is charged until the SOC reaches the target SOC. At this time, the battery temperature rises from T3 to T2 due to the charge of the battery BAT. In the charge period in FIG. 8, since a difference between the battery temperature and the outside air temperature is small, heat released from the battery BAT to the outside air is less. In the example in FIG. 8, the heat stored in the battery BAT is more than the heat released to the outside air, and the battery temperature rises during the charge period.

When the charge of the battery BAT is completed, the control device CTR subsequently starts warming the battery BAT by the battery heater ECH1 at a time t2. The warming start time t2 is determined based on the start time t3 such that the heat stored in the battery BAT by warming does not become waste heat before being used to heat the vehicle compartment. Specifically, the warming start time t2 is set such that the warming of the battery BAT ends at the start time t3 or immediately before the start time t3. Accordingly, it is possible to prevent the heat stored in the battery BAT from completion of the warming to the start time t3 from becoming waste heat, and it is possible to use the heat stored in the battery to heat the vehicle compartment.

The warming start time t2 is also a time when the charge of the battery BAT is completed or a time immediately after the time when the charge is completed. By performing the warming of the battery BAT subsequent to the completion of the charge of the battery BAT, it is possible to prevent the heat stored by charging the battery BAT from becoming waste heat before the warming of the battery BAT, unlike the second comparative example. “Immediately after the time when the charge is completed” means that the predetermined time may be provided between the time when the charge of the battery BAT is completed and the warming start time. The predetermined time at this time is preferably a short time in which a waste heat amount of the battery BAT is small. Detailed processing for determining the warming start time will be described later.

Due to the warming of the battery BAT, the battery temperature is increased from the battery temperature at the warming start time t2 (here, equal to the battery temperature T2 after completion of charge) to the target temperature T1. A difference between the battery temperature T2 at the warming start time t2 and the target temperature T1 is smaller than a difference between the battery temperature T4 at the warming start time t4 and the target temperature T1 in the first comparative example and a difference between the battery temperature T6 at the warming start time 16 and the target temperature T1 in the second comparative example. Therefore, when the battery heater ECH1 is operated at the same output, a warming period in the present embodiment is shorter than warming periods in the first comparative example and the second comparative example.

After the time t3, the heat stored in the battery BAT is used to heat the vehicle compartment, and the battery temperature decreases.

As described above, in the heating control method according to the present embodiment, the battery BAT is first charged before the vehicle V is started, and then the battery BAT is warmed. Accordingly, the battery temperature can be adjusted to be appropriate in order to efficiently heat the vehicle compartment by battery-heat absorption. In addition, since the heat stored in the battery BAT is used to heat the vehicle compartment, it is possible to reduce an electric power consumption amount for the heating, and a decrease in the SOC of the battery BAT due to the heating is reduced. Thus, it is possible to reduce an electricity cost and improve the cruising distance of the vehicle V. Further, the control device CTR determines the charge start time t1 and the warming start time t2 based on the start time t3 of the vehicle V. Accordingly, since the battery BAT can be warmed before the start of the vehicle V to reduce an electric power amount from the external power supply 100, an electricity fee burden on the user can be reduced.

Here, FIG. 9A is a graph in which a vertical axis represents an effective capacity of the battery BAT and a horizontal axis represents the battery temperature. The effective capacity of the battery BAT refers to a capacity that can be used for operating the vehicle V in a charge capacity. As shown in FIG. 9A, when the battery temperature decreases, the effective capacity of the battery BAT decreases. In the present embodiment, by warming the battery BAT before the start of the vehicle V, the heat stored in the battery BAT can be used to heat the vehicle compartment as described above, and, in addition, the effective capacity of the battery BAT can be increased.

FIG. 9B is a graph in which a vertical axis represents a ratio (expressed by a percentage) of an electric power amount P1 in the battery-heat absorption mode to an electric power amount P2 in the outside-air-heat absorption mode, and a horizontal axis represents the battery temperature at the start of the vehicle V. The electric power amounts P1 and P2 are electric power amounts (that is, electricity costs) of the battery BAT consumed when the air conditioner 30 performs heating for a predetermined time (for example, 30 minutes). When the vertical axis is 100%, it means that the electric power amount P1 is equal to the electric power amount P2. When a value of the vertical axis is smaller than 100%, the electric power amount P1 is smaller than the electric power amount P2, that is, the battery-heat absorption mode is more efficient than the outside-air-heat absorption mode.

As shown in FIG. 9B, when the battery temperature at the start of the vehicle V is −10° C. to 15° C., the electric power amount P1 in the battery-heat absorption mode is about 80% to 95% of the electric power amount P2 in the outside-air-heat absorption mode, and, when the battery temperature is 15° C. or higher, the electric power amount P1 in the battery-heat absorption mode converges to about 80% of the electric power amount P2 in the outside-air-heat absorption mode. In this way, in the battery-heat absorption mode, the electric power consumption amount of the battery BAT used for heating the vehicle compartment is smaller than that in the outside-air-heat absorption mode. Accordingly, in the battery-heat absorption mode, it is possible to reduce a decrease in the SOC of the battery BAT due to heating, and to improve the cruising distance of the vehicle V.

[Target Temperature of Battery]

Next, setting of the target temperature T1 at the start time of the vehicle V will be described.

The target temperature T1 is set to be low when the electric power amount from the external power supply 100 consumed when the battery BAT is warmed is to be reduced or when the electricity fee associated with the electric power amount is to be reduced. At this time, the cruising distance of the vehicle V predicted after the warming may be reduced. This is because, as shown in FIG. 9B, the electric power consumption amount of the battery BAT used for heating the vehicle compartment is larger than that in a case where the battery temperature is high, and the decrease in the SOC of the battery BAT due to heating is large.

The target temperature T1 is set to be high when the cruising distance of the vehicle V is to be increased. This is because, as described above, the electric power consumption amount of the battery BAT used for heating the vehicle compartment decreases as the battery temperature increases, so it is possible to reduce the decrease in the SOC of the battery BAT due to heating and to increase the cruising distance.

In this way, the target temperature T1 is set based on at least one of the electric power amount from the external power supply 100 consumed when the battery BAT is warmed or the electricity fee associated with the electric power amount, and the cruising distance of the vehicle V predicted after the battery BAT is warmed.

In the present embodiment, the user can select an electricity fee priority mode in which priority is given to reducing the electricity fee and a cruising distance priority mode in which priority is given to increasing the cruising distance, and the target temperature T1 is set based on the electricity fee priority mode or the cruising distance priority mode selected by the user.

For example, the user selects one of the electricity fee priority mode and the cruising distance priority mode via an application installed in the user terminal 200. The selection of the user is transmitted from the user terminal 200 to the communication device 70 and input to the control device CTR. In the electricity fee priority mode, the target temperature T1 is basically set to be low. On the other hand, in the cruising distance priority mode, the target temperature T1 is basically set to be high. With such a configuration, an intention of the user can be reflected by allowing the user to select which of the electricity fee and the cruising distance is to be prioritized. The selection of the mode by the user may be performed via a navigation device (not shown) instead of the user terminal 200.

First, the electricity fee priority mode will be described in detail. In the electricity fee priority mode, an upper limit value P_lim is set for the electric power amount from the external power supply 100 consumed when the battery heater ECH1 is operated. The target temperature T1 is set based on the upper limit value P_lim. Since the upper limit value P_lim is set, the warming of the battery BAT does not continue beyond the upper limit value, and thus the electricity fee burden on the user can be reduced. Here, the target temperature T1 set based on the upper limit value P_lim, that is, the target temperature T1 in the electricity fee priority mode is also referred to as a target temperature T1′.

Hereinafter, the upper limit value P_lim and the target temperature TV based on the upper limit value P_lim will be described with reference to FIG. 9C.

FIG. 9C is a graph in which a vertical axis represents an electric power consumption amount of the battery heater ECH1 (that is, the electric power consumption amount from the external power supply 100) and a horizontal axis represents the battery temperature. A graph A in FIG. 9C is a graph showing a relationship between the battery temperature when the battery BAT is warmed by the battery heater ECH1 and the electric power consumption amount of the battery heater ECH1 when the battery temperature is 10° C. at the warming start time. Similarly, graphs B and C in FIG. 9C are graphs when the battery temperature is 0° C. and −10° C. at the warming start time, respectively.

When the upper limit value P_lim is set for the electric power consumption amount of the battery heater ECH1, the target temperature T1′ at the start time of the vehicle V is set based on the upper limit value P_lim and the battery temperature at the warming start time. Specifically, the battery temperature at an intersection between each graph and the upper limit value P_lim is the target temperature T1′. For example, in the case of the graph C, the target temperature T1′ of the battery BAT is about 0° C., and the electric power amount P1 in the battery-heat absorption mode is about 85% of the electric power amount P2 in the outside-air-heat absorption mode (see FIG. 9B). When the warming of the battery BAT is further continued, a heating effect of battery-heat absorption can be further improved, whereas an electricity fee associated with the electric power consumption amount from the external power supply 100 is increased. By setting the upper limit value P_lim for the electric power consumption amount of the battery heater ECH1, it is possible to reduce the electricity fee burden on the user.

Here, the upper limit value P_lim is preferably determined based on a comparison between the electric power amount P1 in the battery-heat absorption mode and the electric power amount P2 in the outside-air-heat absorption mode. When the upper limit value P_lim is set to be excessively small, there is a possibility that heating of the vehicle compartment by battery-heat absorption is not efficient. Therefore, while reducing the electricity fee burden by setting the upper limit value P_lim, the electric power amount P1 in the battery-heat absorption mode and the electric power amount P2 in the outside-air-heat absorption mode are compared, and the battery BAT can be heated to such an extent that the heating of the vehicle compartment is efficiently performed by battery-heat absorption. For example, even when the battery temperature at the warming start time is −10° C. as in the graph C in FIG. 9C, the upper limit value P_lim is set such that the battery BAT can be warmed to a temperature at which the electric power amount P1 in the battery-heat absorption mode is about 85% of the electric power amount P2 in the outside-air-heat absorption mode.

The upper limit value P_lim may also be determined based on a comparison between the cruising distance of the vehicle V in the battery-heat absorption mode and the cruising distance of the vehicle V in the outside-air-heat absorption mode, instead of the comparison between the electric power amount in the battery-heat absorption mode and the electric power amount in the outside-air-heat absorption mode.

Next, the cruising distance priority mode will be described in detail. In the cruising distance priority mode, the upper limit value P_lim is not set for the electric power amount from the external power supply 100, and the battery BAT is warmed before the start of the vehicle V until the battery temperature reaches the predetermined target temperature T1, regardless of the battery temperature at the warming start time.

As shown in FIG. 9B, a ratio of the electric power amount P1 to the electric power amount P2 converges to about 80% when the battery temperature at the start of the vehicle V is 15° C. or higher. Thus, even when the target temperature T1 at the start of the vehicle V is higher than 15° C. in the cruising distance priority mode, an effect obtained by battery-heat absorption is hardly improved. That is, even when the battery BAT is excessively warmed before the start of the vehicle V, it is difficult to expect a better effect.

Therefore, the target temperature T1 in the cruising distance priority mode is preferably determined to be a battery temperature (for example, 15° C.) at which the ratio of the electric power amount P1 in the battery-heat absorption mode to the electric power amount P2 in the outside-air-heat absorption mode is a predetermined value (for example, 80%). The above-described predetermined value can be determined as desired.

By determining the target temperature T1 in this way, it is possible to prevent the battery BAT from being continuously warmed by the battery heater ECH1 to a battery temperature (a temperature higher than 15° C. in the example in FIG. 9B) at which no improvement in the effect obtained by battery-heat absorption is expected. Therefore, excessive warming can be reduced, and the electricity fee burden on the user can be reduced.

[Processing for Determining Charge Start Time and Warming Start Time]

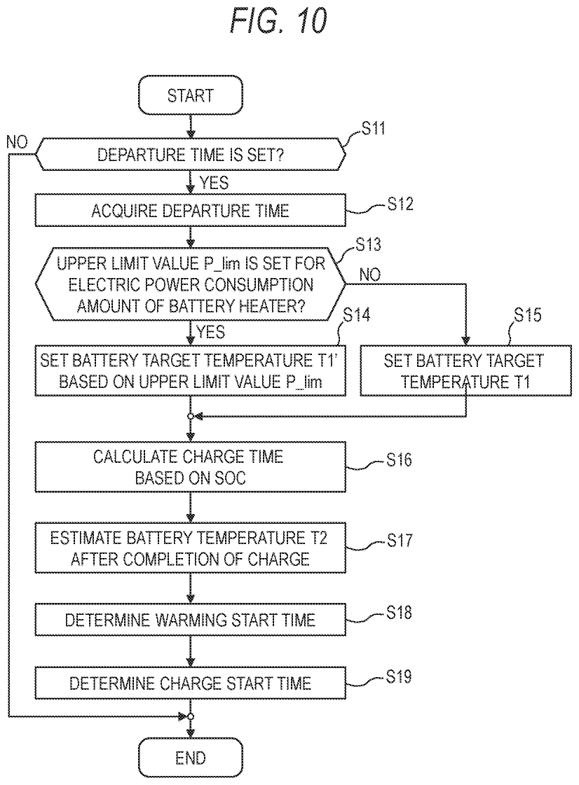

Next, an example of processing for determining the charge start time and the warming start time in the heating control method according to the present embodiment will be described with reference to FIG. 10. In the following description, the reference numerals used in FIG. 8 are used.

The control device CTR first determines whether the start time t3 of the vehicle V is set (step S11). For example, when the schedule information of the vehicle V is set in the user terminal 200, the control device CTR acquires the schedule information of the vehicle V via the communication device 70. Then, the control device CTR determines that the start time t3 of the vehicle V is set based on the schedule information (step S11: YES), and acquires the start time t3 of the vehicle V (step S12). When it is determined that the start time t3 is not set, the processing ends (step S11: NO).

The control device CTR determines whether the upper limit value P_lim is set for the electric power consumption amount of the battery heater ECH1 (step S13). When the upper limit value P_lim is set (step S13: YES), the target temperature T1′ based on the upper limit value P_lim is set as the target temperature after completion of warming of the battery BAT (step S14). When the upper limit value P_lim is not set (step S13: NO), the predetermined target temperature T1 is set as the target temperature after completion of warming of the battery BAT (step S15).

After step S14 or step S15, the control device CTR determines a charge time during which the battery BAT is charged with the electric power from the external power supply 100 (step S16). Specifically, the control device CTR calculates the charge time based on a SOC before start of charge and the target SOC.

Next, the control device CTR estimates the battery temperature T2 after completion of charge (step S17). Specifically, the control device CTR estimates the battery temperature T2 after the completion of charge based on prediction data on the outside air temperature, a change in the battery temperature associated with the outside air temperature, the charge time, a change in the battery temperature associated with the charge, and the like.

Next, the control device CTR determines the warming start time t2 of the battery BAT warmed by the battery heater ECH1 (step S18). Specifically, based on the target temperature T1 or T1′ after completion of warming, the battery temperature T2 after the completion of charge, and an output of the battery heater ECH1, the control device CTR determines the warming start time t2 by calculation backward from the start time t3. Here, the output of the battery heater ECH1 is, for example, a maximum output.

Next, the control device CTR determines the charge start time t1 (step S19). Specifically, the control device CTR determines the charge start time t1 based on the charge time and the warming start time t2. For example, when a charge completion time is the warming start time t2, the charge start time t1 is a time that is earlier than the time t2 by the charge time. After the charge start time t1 is determined, the processing ends.

By determining the charge start time and the warming start time by the above processing, it is possible to appropriately determine the time when the charge and the warming of the battery BAT are started before the start of the vehicle V, and it is possible to efficiently use the heat stored in the battery BAT to heat the vehicle compartment.

Although the embodiment has been described above with reference to the drawings, it is needless to say that the present invention is not limited to such an example. It is apparent that those skilled in the art can conceive of various modifications and alterations within the scope described in the claims, and it is understood that such modifications and alterations naturally fall within the technical scope of the present invention. In addition, respective constituent elements in the above-described embodiment may be freely combined without departing from the gist of the invention.

For example, the battery temperature control circuit 40 may allow the coolant C1 to perform heat exchange with the drive unit DU. During driving of the drive unit DU (for example, when the vehicle V travels), the drive unit DU has a high temperature. With such a configuration, the drive unit DU is cooled down by the coolant C1, and the coolant C1 that receives heat from the drive unit DU is warmed. The coolant C1 that receives the heat from the drive unit DU can supply the heat to the heat pump circuit 31 via the first heat exchanger 50. That is, during heating of the vehicle compartment, the air conditioner 30 can also use the heat from the drive unit DU.

The battery temperature control circuit 40 may be connected to the temperature increase circuit 32 via an on-off valve. In this case, the vehicle compartment can be heated by the coolant C1 flowing through the battery temperature control circuit 40 and the temperature increase circuit 32 through the on-off valve without passing through the first heat exchanger 50.

The coolant in the battery temperature control circuit 40 may be different from the coolant in the temperature increase circuit 32.

In the above-described embodiment, the upper limit value P_lim is set for the electric power amount from the external power supply 100, but the present invention is not limited thereto. For example, an upper limit value may be set for the electricity fee associated with the electric power amount from the external power supply 100. Accordingly, the user can set the upper limit value in an easy-to-understand manner.

In the present description, at least the following matters are described. Although corresponding constituent elements or the like in the above-described embodiment are shown in parentheses, the present invention is not limited thereto.
(1) A heating control method for a vehicle (vehicle V) including a battery (battery BAT) chargeable with electric power from an external power supply (external power supply 100), and an air conditioner (air conditioner 30) that enables to heat a vehicle compartment with consumption of electric power of the battery, the vehicle being capable of traveling by the electric power of the battery, the heating control method including:
a start time acquisition step in which a start time (start time t3) of the vehicle is acquired based on schedule information of the vehicle;
a charge step in which the battery is charged, from a first time (charge start time t1) before the start time, with the electric power from the external power supply;
a warming step in which the battery is warmed, from a second time (warming start time t2) between a completion time of the charge of the battery and the start time, by the electric power of the external power supply; and
a heating step in which the vehicle compartment is heated after the start time,
in which an operation mode of the heating step includes a battery-heat absorption mode in which the vehicle compartment is heated through a use of heat stored in the battery due to charge and warming of the battery, and
the first time and the second time are determined based on the start time.

According to (1), the battery is first charged before the vehicle is started, and then the battery is warmed. Accordingly, before the vehicle is started, the battery temperature can be adjusted to be appropriate for heating in the battery-heat absorption mode. In addition, since the heat stored in the battery is used to heat the vehicle compartment, an electric power amount of the battery consumed for heating the vehicle compartment can be reduced, and a decrease in a SOC of the battery due to heating is reduced. Thus, it is possible to reduce an electricity cost and improve a cruising distance of the vehicle. Further, the first time and the second time are determined based on the start time of the vehicle. Accordingly, the battery can be warmed before the vehicle is started such that the electric power amount from the external power supply is reduced, and thus an electricity fee burden on the user can be reduced.
(2) The heating control method for a vehicle according to (1),
in which the first time is a time when a predetermined time elapses since (time t0) a charger (charger OBC) mounted on the vehicle is connected to the external power supply.

According to (2), the first time can bring a charge period closer to the start time as compared to a case where charge is started at the time when the charger is connected to the external power supply. Therefore, it is possible to prevent occurrence of a period in which heat stored in the battery during the charge becomes waste heat before the start of the vehicle.
(3) The heating control method for a vehicle according to (1) or (2),
in which the step of warming the battery ends at the start time or immediately before the start time.

According to (3), it is possible to prevent the heat stored in the battery from becoming waste heat from completion of warming to the start time, and it is possible to use the heat stored in the battery to heat the vehicle compartment.
(4) The heating control method for a vehicle according to (3),
in which the second time is determined based on:
   the start time;
   a target temperature of the battery at the start time;
   a temperature of the battery after completion of the charge of the battery; and
   an output of a heater (battery heater ECH1) that warms the battery until the temperature of the battery reaches the target temperature.

According to (4), it is possible to appropriately determine the warming start time of the battery before the start of the vehicle, and it is possible to efficiently use the heat stored in the battery to heat the vehicle compartment.
(5) The heating control method for a vehicle according to any one of (1) to (4),
in which a target temperature of the battery at the start time is determined based on at least one of:
   an electric power amount from the external power supply consumed when the battery is warmed, or an electricity fee associated with the electric power amount; and
   a cruising distance of the vehicle predicted after the warming.

According to (5), the target temperature of the battery can be set in consideration of the electric power amount from the external power supply, the electricity fee, and the cruising distance.
(6) The heating control method for a vehicle according to (5),
in which a user is allowed to select an electricity fee priority mode in which priority is given to reducing the electricity fee or a cruising distance priority mode in which priority is given to increasing the cruising distance.

According to (6), an intention of the user can be reflected by allowing the user to select which of the electricity fee and the cruising distance is to be prioritized.
(7) The heating control method for a vehicle according to (6),
in which in the electricity fee priority mode, an upper limit value is set for the electric power amount from the external power supply or the electricity fee associated with the electric power amount.

According to (7), it is possible to reduce the electricity fee burden on the user.
(8) The heating control method for a vehicle according to (7),
in which the operation mode of the heating step includes the battery-heat absorption mode, and an outside-air-heat absorption mode in which the vehicle compartment is heated by absorbing heat from outside air without using heat stored in the battery, and
the upper limit value is set based on a comparison between an electric power amount in the outside-air-heat absorption mode and an electric power amount in the battery-heat absorption mode or a comparison between a cruising distance of the vehicle in the outside-air-heat absorption mode and a cruising distance of the vehicle in the battery-heat absorption mode.

According to (8), it is possible to warm the battery to such an extent that heating of the vehicle compartment can be efficiently performed by battery-heat absorption while reducing the electricity fee burden.

What is claimed is:

1. A heating control method for a vehicle including a battery chargeable with electric power from an external power supply, and an air conditioner that enables to heat a vehicle compartment with consumption of electric power of the battery, the vehicle being capable of traveling by the electric power of the battery, the heating control method comprising:
a start time acquisition step in which a start time of the vehicle is acquired based on schedule information of the vehicle:
a charge step in which the battery is charged, from a first time before the start time, with the electric power from the external power supply:
a warming step in which the battery is warmed, from a second time between a completion time of the charge of the battery and the start time, by the electric power from the external power supply; and
a heating step in which the vehicle compartment is heated after the start time,
wherein an operation mode of the heating step includes a battery-heat absorption mode in which the vehicle compartment is heated through a use of heat stored in the battery due to charge and warming of the battery, and
the first time and the second time are determined based on the start time.

2. The heating control method for the vehicle according to claim 1,
wherein the first time is a time when a predetermined time elapses since a charger mounted on the vehicle is connected to the external power supply.

3. The heating control method for the vehicle according to claim 1,
wherein the warming step ends at the start time or immediately before the start time.

4. The heating control method for the vehicle according to claim 3,
wherein the second time is determined based on:
the start time;
a target temperature of the battery at the start time;
a temperature of the battery after completion of the charge of the battery; and
an output of a heater that warms the battery until the temperature of the battery reaches the target temperature.

5. The heating control method for the vehicle according to claim 1,
wherein a target temperature of the battery at the start time is determined based on at least one of:
an electric power amount from the external power supply consumed when the battery is warmed, or an electricity fee associated with the electric power amount; and
a cruising distance of the vehicle predicted after the warming.

6. The heating control method for the vehicle according to claim 5,
wherein a user is allowed to select an electricity fee priority mode in which priority is given to reducing the electricity fee or a cruising distance priority mode in which priority is given to increasing the cruising distance.

7. The heating control method for the vehicle according to claim 6,
wherein in the electricity fee priority mode, an upper limit value is set for the electric power amount from the external power supply or the electricity fee associated with the electric power amount.

8. The heating control method for the vehicle according to claim 7,
wherein the operation mode of the heating step includes the battery-heat absorption mode, and an outside-air-heat absorption mode in which the vehicle compartment is heated by absorbing heat from outside air without using heat stored in the battery, and
the upper limit value is set based on a comparison between an electric power amount in the outside-air-heat absorption mode and an electric power amount in the battery-heat absorption mode, or a comparison between a cruising distance of the vehicle in the outside-air-heat absorption mode and a cruising distance of the vehicle in the battery-heat absorption mode.
